(19) United States
(12) Patent Application Publication
(10) Pub. No.: US 2023/0151186 A1
(43) Pub. Date: May 18, 2023

(54) RESIN COMPOSITE

(71) Applicant: First Graphene Ltd, Henderson (AU)

(72) Inventors: Paul LADISLAUS, Sedgefield (GB); Neil ARMSTRONG, Henderson (AU)

(21) Appl. No.: 18/058,684

(22) Filed: Nov. 23, 2022

Related U.S. Application Data
(63) Continuation of application No. PCT/AU2021/050495, filed on May 25, 2021.

(30) Foreign Application Priority Data
May 25, 2020 (AU) 2020901689

(51) Int. Cl. C08K 7/00; C08K 9/04; C08J 5/04; C08J 7/04; B32B 1/08; B32B 27/20; B32B 27/08; B32B 27/36; B32B 5/02; B32B 13/12

(52) U.S. Cl. CPC C08K 7/00; C08K 9/04; C08J 5/043; C08J 7/042; B32B 1/08; B32B 27/20; B32B 27/08; B32B 27/36; B32B 5/028; B32B 13/12; C08J 2367/00; C08K 2201/005; B32B 2264/104; B32B 2264/107; B32B 2307/54; B32B 2307/7265; B32B 2262/101; B32B 2255/28; B32B 2255/10; B32B 2255/26; B32B 2597/00; B32B 2264/108; B32B 2262/106; B32B 2307/302; B32B 2307/714; B32B 2250/24; B32B 2262/0269; B32B 2260/021; B32B 2260/046; B32B 2605/12; B32B 2264/302; B32B 2264/303; B32B 2439/40; B32B 2419/06; B32B 2264/201

(57) ABSTRACT

A water-resistant composition 20 includes a graphene material 22 forming a matrix with a resin 23. The matrix can include reinforcing fibres such as glass fibres. The composition can include the graphene material 22, a polyester resin 23 and glass fibre reinforcement. Multiple forms of the composite can be provided in layers, such as a barrier layer containing the graphene material 22 in a resin 23 and a second layer containing reinforcing material. A cosmetic coloured gel coat can be applied to the composition and a clear gel coat applied over the cosmetic coating. The graphene material can include graphene platelets 22 dispersed within the resin. The graphene material can provide up to 5% by weight (% wt) of the composite, preferably up to 2% wt of the composite, more preferably between 1% wt and 2.5% wt of the composite and yet more preferably 2% wt of the composite. The composition can be applied to a boat hull, a pipe, a swimming pool, a spa or a tank, or a surface subject to prolonged contact with or submersion in water.

### CROSS-REFERENCE TO RELATED APPLICATIONS

The present application is a continuation of International Application No. PCT/AU2021/050495, filed May 25, 2021, which claims priority to Australian Application No. 2020901689, filed May 25, 2020, both of which are incorporated by reference herein.

### TECHNICAL FIELD

The present invention relates to resin based composite, structural or coating systems, such as having a surface exposed to water or other liquids for prolonged periods where penetration of the water or liquid into the structure or coating causes degradation.

One or more forms of the present invention is particularly applicable to, though not limited to, structures and/or coatings for a swimming pool, a spa, a boat hull, a tank, water and waste water tanks, piping, a storage vessel, cladding or roofing material, or the like, where water penetration, such as by osmosis, into the structure or coating through prolonged exposure to the water causes degradation, such as blistering or cracking.

### BACKGROUND TO THE INVENTION

By way of example, degradation through osmosis is a major problem for products that are immersed in or exposed to contact with water or other liquid for prolonged periods, such as boat hulls, swimming pools and spas, a tank, water and waste water tanks, piping, storage vessels, cladding or roofing, or the like, particularly those created using resin and glass fibre.

The degradation often presents as blistering or cracking at the surface, thereby reducing structural integrity and aesthetics. This is typically symptomatic of the osmosis leading to moisture build-up in voids. Apart from the cosmetic impact, this could ultimately lead to delamination and loss of mechanical strength.

It is possible that, particularly under acidic conditions—for example, due to soil pH—calcium carbonate could dissolve into absorbed water pockets, forming carbonic acid. This will encourage osmosis into the system.

It is known that all resins will absorb moisture. It is therefore important to understand how the absorbed moisture will affect the resin and the resin/fibre bond in a laminate, as this could otherwise lead to a gradual and long-term loss in mechanical properties.

Hydrolysable ester groups present in polyester and vinylester resins make those resins susceptible to water degradation when the resins are immersed in water for prolonged periods. Over a 1 year period of immersion in water, the interlaminar shear strength (ILSS) retention of the resin may be as low as approximately 65% of its ILSS for a thin polyester laminate and as low as approximately 90% for an epoxy laminate (from Gurit ‘Guide to Composites’).

The mechanism for water absorption is typically referred to as osmosis.

All laminates will allow very small amounts of water to pass through in vapour form. As a result, the water will react with hydrolysable components in the laminate, forming tiny cells of concentrated solution. Osmosis then occurs as more water is drawn through the semi-permeable membrane of the laminate to dilute the solution (equalize osmotic pressure).

This additional water absorbed as a result of osmosis increases the fluid pressure in the cell significantly, eventually distorting, or in extreme cases bursting, the laminate or coating, such as a gel coat.

A gel coat (or gel coat) is a material used to provide a high-quality protective coating on the visible surface of a fibre-reinforced composite. Thermosetting polymers based on epoxy or unsaturated polyester resins are generally used as gel coats. Gel coats are readily applied to moulds whilst in a liquid state and cure to form cross-linked polymers. The gel coat is typically backed with thermoset polymer matrix composites, such as mixtures of polyester resin and fiberglass, or with epoxy resin which is most commonly used with carbon fibre for higher specific strength.

Particularly in fibre-reinforced composites, the polymer matrix acts as the membrane. As water diffuses through the polymer, any soluble solid material dissolves, forming a strong/concentrated solution. Water then diffuses (such as by osmosis) into that strong solution until the concentration gradient is reduced to zero.

The volume of the solution will increase with dilution and exert pressure on the surrounding material. When the stresses exceed a critical level, delamination occurs leading to blistering.

Resin rich layers are typically applied next to the gel coat to minimise water ingress, by reducing water permeability. Epoxy-based resins are also much better at withstanding water ingress, in addition to improved chemical resistance and mechanical strength.

A major problem is the potential blistering of boat hulls, pools, spas and like products immersed in or exposed to water for long periods. This is typically symptomatic of osmosis occurring in the system, leading to moisture build-up in voids.

Apart from the cosmetic impact, this could ultimately lead to delamination and loss of mechanical strength.

Blisters are cracks that propagate parallel to the surface in the back-up/backing layer, between the gel-coat and the first fibre reinforced layer. As mentioned above, apart from boat hulls, blistering also occurs in other structures based on polyester matrix composites, such as tanks and swimming pools.

It is possible that, under acidic conditions—for example due to soil pH for in-ground pools and tanks—the calcium carbonate could dissolve into absorbed water pockets, forming carbonic acid. This will encourage osmosis into the system and eventual degradation of the structure.

Enhanced mechanical strength of a resin composite product is hugely beneficial, particularly where there is an associated reduction in volume of material used in the product's structure and/or a reduction in manufacturing complexity or time.

It is to be understood that, if any prior art is referred to herein, such reference does not constitute an admission that the prior art forms a part of the common general knowledge in the art, in Australia or any other country.

### SUMMARY OF THE INVENTION

An aspect of the present invention provides a material composition comprising at least a combination of a resin and a graphene material.

Another aspect of the present invention provides a water-resistant barrier material including a material composition comprising at least a combination of a resin and a graphene material.

The graphene material is preferably dispersed within the resin e.g. forming a resin-graphene material matrix.

The composition may preferably include a reinforcing material.

The composition may be an osmotic barrier, such as for a product configured for prolonged exposure to or immersion in water or other liquid.

The resin can be or include a polyester resin (PE), vinyl ester, epoxy or other resin base.

The reinforcing material can include or be glass fibre, carbon fibre, poly-paraphenylene terephthalamide (aka Kevlar®) and/or other synthetic material.

The reinforcing material may be in the form of fibres, matting or mesh, providing reinforcement, such as used in a laying down/laying on application process. The reinforcing material may be spray, machine or manually applied.

The graphene material can include at least one of graphene and functionalised graphene, such as graphene oxide (GO).

The graphene material may include oxygen or at least one oxygen-containing group.

At least a proportion of the oxygen or the at least one oxygen-containing group may be bonded to or intercalated at the edges of graphene platelets.

At least a proportion of the at least one oxygen containing group may include at least one of a carboxylate, an ester, an epoxy and a carbonyl group.

The oxygen or the at least one oxygen containing group is preferably present in the graphene material in quantities of around 0.5% to 10% wt, preferably 1% to 5% wt, more preferably 1% to 3% wt, and yet more preferably 1% to 2% wt.

The inclusion of oxygen or the at least one oxygen containing group is understood to enhance dispersion of the graphene within the resin.

The composition can provide a fibre (preferably glass fibre) reinforced system, which can find application in significantly reducing water diffusion into the composition or system. The composition can therefore reduce or prevent damage to the system by hydrolysis and/or by other mechanisms, particularly over time.

The composition can include graphene as platelets. Providing graphene platelets within the composition beneficially avoids the need for functionalisation or additional modification to incorporate the graphene material with the resin.

Preferably the graphene includes nano particles, such as at least one of nano-platelets, nano-rods and nano-spheres.

The oxygen or the at least one oxygen-containing group may be bonded to or intercalated at the edges of the graphene platelets.

Preferably the graphene material can have a D50 (volumetric) lateral size of at or about 20 microns. Other volumetric lateral sizes are envisaged to fall within the scope of the present invention, such as in the range in the range 100 nanometres to 100 microns, or in the range 500 nanometres to 50 microns, or in the range 1 micron to 50 microns, or in the range 10 microns to 25 microns.

Fewer component layers of a structural and/or coating arrangement can be required compared to previous structural/coating arrangements, particularly for boat hulls, tanks, pools, spas, storage/reservoir tanks, water and waste water tanks, piping, storage vessels, and the like.

One or more forms of the present invention can beneficially avoid a need for a ceramic filled polyester (PE) resin layer and the outer calcium carbonate layers in the structure or coating arrangement.

The graphene material can provide up to 5% by weight (% wt) of the composition. The graphene material can provide up to 3% wt of the composition, preferably up to 2% wt of the composition, more preferably between 1% wt and 2.5% wt of the composition and yet more preferably 2% wt of the composition.

The composition is preferably for use in a structure for a boat hull, swimming pool, spa, tank or the like, such as where a surface of the structure is immersed/submersed in a liquid, preferably predominantly water, for a prolonged period.

A further aspect of the present invention provides a product comprising a boat hull, swimming pool, spa, tank, water or waste water tank, piping or storage vessel having a structure including a composition according to one or more of the aforementioned forms of the composition.

It will be appreciated that the composition can be termed a composite having a composite structure of the graphene material within the resin e.g. forming a matrix.

A further aspect of the present invention includes a method of producing a product for prolonged immersion or submersion in water, the method including providing an aforementioned form of the composition, coating the composition with a coloured gel coat and subsequently coating the coloured gel coat with a top coat gel coat.

Another aspect of the present invention provides an osmotic diffusion resistant composite including a matrix of a graphene material, a resin and a reinforcing material.

The graphene material preferably includes functionalised graphene. The graphene material contains oxygen or at least one oxygen-containing group. The graphene material preferably includes graphene platelets.

The composite is preferably part of a swimming pool, a spa, a boat hull, a tank, cladding or roofing material.

Preferably the graphene platelets are dispersed within the resin.

The composite may include graphene platelets of between 100 nanometres to 100 microns, or in the range 500 nanometres to 50 microns, or in the range 1 micron to 50 microns, or in the range 10 microns to 25 microns, or is at or about 20 microns, such as measured in a lateral dimension of the platelets.

The graphene material preferably provides up to 5% by weight (% wt) of the composite, preferably up to 2% wt of the composite, more preferably between 1% wt and 2.5% wt of the composite and yet more preferably 2% wt of the composite.

The composite may be part of a swimming pool, a pipe, a spa, a boat hull, a tank, a water tank or waste water tank, piping, a pipe lining, a storage vessel, cladding or roofing material.

The composite may be provided as at least one layer. The composite may be provided as a lining or coating over a surface of a substrate, such as an interior and/or exterior surface of the underlying product e.g. a surface of a swimming pool, a spa, a tank, a pipe etc.

The composite may be provided as at least one layer having an additional reinforcing material and at least one other layer not having the reinforcing material.

The composite may be provided in multiple layers, at least two said layers having different mechanical properties from each other.

The different mechanical properties can be due to different sizes of graphene material and/or due to different % wt of the graphene material with respect to the resin of each said layer. At least one of the layers preferably includes at least one of reinforcing fibres, matting or mesh.

The composite may be one of multiple layers of resin composite in the product (i.e. can be one of two or more differing resin compositions) or may be as two or more layers of the same composite in product (with or without other resin composite layers).

As a result of having fewer layers, the composition/system of one or more forms of the present invention can overall be thinner than the known composite equivalent. This helps to reduce overall weight, reduces total amount of materials and improves longevity of the finished product.

Inclusion of the graphene material dispersed in the resin

It will be appreciated that one or more forms of the present invention may be provided as a first layer of a composition containing a resin and a graphene material, such as a water/water vapour barrier, and a second layer may be provided as a structural layer including resin, graphene material and a reinforcing material.

The reinforcing material, may be or include glass fibre, carbon fibre poly-paraphenylene terephthalamide (aka Kevlar®) and/or other synthetic material, as mentioned above.

It will be appreciated that the graphene material enhances at least one mechanical property of the resin, compared to the resin without the graphene material. The at least one mechanical property may include mechanical strength, flexural stiffness, stress and/or strain characteristics.

A further aspect of the present invention provides a product incorporating at least one resin composite, the at least one resin composite containing a resin and a graphene material dispersed within resin.

The product may be a swimming pool, a pipe, a spa, a boat hull, a tank, a water tank or waste water tank, piping, a storage vessel, cladding or roofing material.

A pipe may be lined with the composition. The pipe may be cementitious or of concrete.

The product may include multiple layers of the at least one composite. At least one of the layers may include a reinforcing material. A first layer may be provided as a water/water vapour barrier layer, and a second may be provided as a structural layer.

One or more forms of the present invention provides enhanced barrier performance, such as enhanced barrier performance of GRP coatings for pipes, such as concrete pipes. Embodiment of the present invention are particularly beneficial where the reduced permeability can increase the lifetime of the pipe by reducing the amount of water ingress. The water phase could contain salts e.g. sulphates, that could lead to corrosion of the concrete pipe/system, and hence the additional benefit of the composition.

Preferably the structural layer includes a reinforcing material, such as glass fibre, carbon fibre or other synthetic material.

A cosmetic layer and/or a protective layer (such as UV protective) may be provided over the first or second layer.

### BRIEF DESCRIPTION OF THE DRAWINGS

One or more forms of the present invention will hereinafter be described with reference to the accompanying drawings, in which:

FIG. 1a shows a representation of moisture diffusion into a composite results in degradation.

FIG. 1b shows a representation of resistance to degradation by presence of graphene material within the composite.

FIG. 2 shows a chart of moisture absorption data from comparative trials of at least one embodiment of the present invention relative to a base sample having Reinforced Fibre (RF) Polyester (PE) resin.

FIG. 3 shows a chart of sorption curves from comparative testing of at least one embodiment of the present invention relative to a base sample having Reinforced Fibre (RF) Polyester (PE) resin.

FIGS. 4a, 4b and 4c show representations of the cross-section of composite structures showing respective layers. FIG. 4a shows the cross-section of a current composite structure for a pool, spa or boat hull or the like, and FIG. 4b represents an embodiment of the present invention with a resin incorporating a graphene material. FIG. 4c shows an alternative structure with a composite layer as a water barrier and a second layer as a structural layer.

FIG. 5 shows a histogram of flexural stress versus sample grade and concentration of graphene material (platelets in this example) in the composition/composite.

FIG. 6 shows a histogram of flexural modulus versus grade and concentration of graphene material (platelets in this example) in the composition/composite.

### DETAILED DESCRIPTION

In the following detailed description, reference is made to accompanying drawings which form a part of the detailed description. The illustrative embodiments described in the detailed description, depicted in the drawings and defined in the claims, are not intended to be limiting. Other embodiments may be utilised and other changes may be made without departing from the spirit or scope of the subject matter presented. It will be readily understood that the aspects of the present disclosure, as generally described herein and illustrated in the drawings can be arranged, substituted, combined, separated and designed in a wide variety of different configurations, all of which are contemplated in this disclosure.

An osmotic cracking process can occur by the following mechanism:
Microcavities present in the system are filled by water.
Small molecules or salts, initially present in the matrix (e.g. catalyst residues) or formed during hydrolysis, are dissolved by water and accumulate into microcavities.
The material layer separating a microcavity and the water bath is permeable to water, but considerably less permeable to larger molecules.
This causes it to act as a semi-permeable membrane, leading to osmotic pressure developing in the cavity.

The following stages of an osmotic cracking process have been identified (see ‘Humid Ageing of Organic Matrix Composites’—X. Colin and J. Verdu, as published in ‘Durability of Composites in a Marine Environment’, P. Davies and Y. D. S. Rajapakse (eds.), Solid Mechanics and Its Applications 208):
0 to t₁—physical water sorption. The system reaches an equilibrium based on water solubility at t₁.
t₁ to t₂—system is at a pseudo-equilibrium. Hydrolysis occurs, but the conversion ratio remains low.
Time>t₂—propagation of osmotic cracks. The increased rate of mass uptake corresponds to the increase of volume created by cracking. The time to t₂ is representative of the material stability.
Time=t₃—crack coalescence. The solutes responsible for osmosis are transferred out of the system, causing a rapid reduction in mass after t₃.

There are two main matrix categories:
Polymers which react chemically with water, for instance polyesters. Failure is considered to result from the following causal chain: Polymer+water->water absorption->polymer hydrolysis->degradation of the macromolecular backbone->embrittlement->failure:
Non-reactive polymers, for instance amine cured epoxies. Failure results from the following causal chain: Polymer+water->water absorption->polymer swelling->stress state->failure.

For uncoupled fibres, there are various possible causes of a specific attack of water in the interfacial region:
The presence of interfacial voids allowing a fast penetration of water in deep layers
Glass fibers have an alkaline character, which may be able to play a catalytic role on ester hydrolysis.

Hydrolysis is accelerated in the presence of glass, due to basic catalysis, and the coupling agent displays a limited but significant stabilizing effect. Coupling agents are expected to have a positive effect on the composite stability in humid ageing conditions.

Accelerated immersion testing was conducted using a pressure vessel at temperature to reduce testing time. Accelerated test results are achieved within 10 to 100 hrs compared to months using a conventional testing standard of months. The following Table 1 shows samples 1-3 that were tested:

TABLE 1

| | | | | | Relative |
|---|---|---|---|---|---|
| | | | | | to base |
| Sample | Description | Gradient | D (120° C.) | D (25° C.) | (120° C.) |
| 1 | 5 mm Base | 0.0016 | 5.02655E−07 | 1.71768E−07 | 100% |
| | RF PE sample | | | | |
| 2 | 5 mm 1% PG | 0.0013 | 3.31831E−07 | 1.13394E−07 | 66% |
| | 20 RF PE sample | | | | |
| 3 | 5 mm 2% PG | 0.0012 | 2.82743E−07 | 9.66196E−08 | 56% |
| | 20 RF PE sample | | | | |

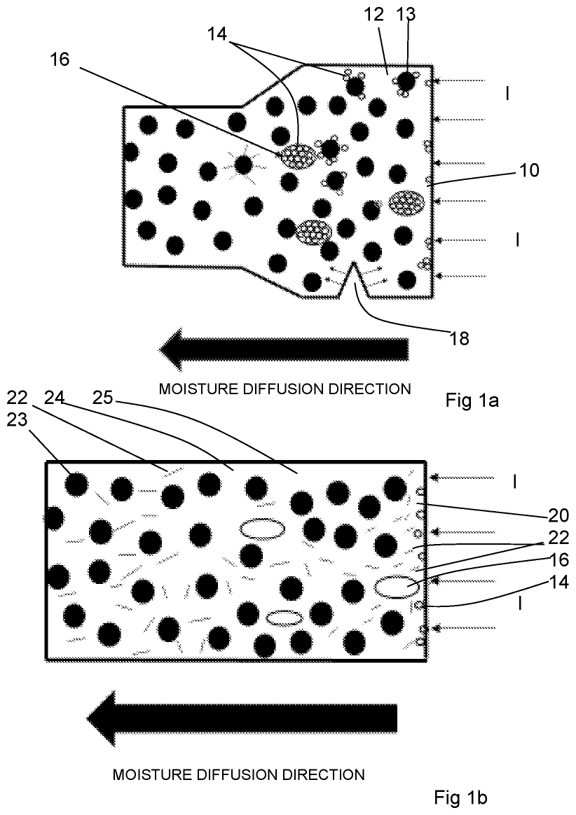

FIG. 1a shows a known composite structure/system 10 wherein water molecules 14 are able to penetrate into the composite 10 at a water-structure interface T due to poor or limited water barrier characteristics of the composite. Water molecules 14 can collect in voids 16 in the resin matrix 12 and can aggregate at fibre reinforcements 13 (e.g. glass fibre strands)

Water penetrating into the composite causes blistering/cracking 18, leading to structural and/or aesthetic degradation of the composite/product.

FIG. 1b shows a composite structure/system 20 according to at least one embodiment of the present invention, wherein graphene material 22, such as in the form of graphene platelets, and a resin 24 form a composite structure matrix 25 that reduces or prevents significant water molecule 14 diffusion into the composite structure/system 20, thereby avoiding or at least reducing degradation and enhancing mechanical strength of the product. Water molecules 14 have reduced penetration into the matrix at the water-matrix interface ‘I’. The composite 20 preferably includes reinforcing 23, such as reinforcing fibres e.g. glass fibres.

The product may be, for example, a swimming pool, a spa, a boat hull, tank (such as a water tank), cladding or roofing, such as formed using reinforcing fibres e.g. glass reinforced composites.

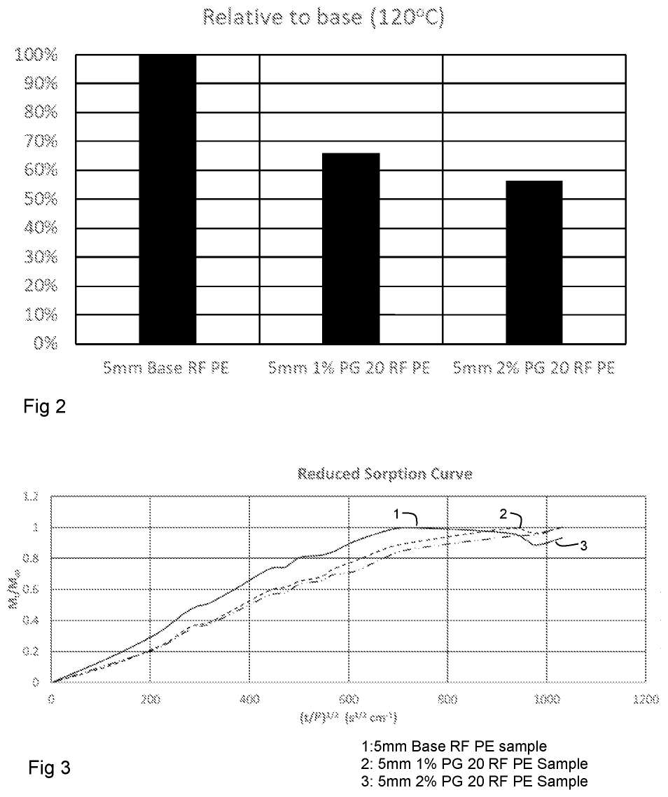

FIG. 2 shows examples (samples 2 and 3) of embodiments of the present invention compared to the base sample of 5 mm base reinforce glass fibre (RF) polyester (PE) resin structure (sample 1).

A composition of at least one embodiment of the present invention includes the graphene material combined with

The same data of FIG. 2 is represented in FIG. 3 as sorption curves.

Curve 1 represents the 5 mm base RF PE sample. Curve 2 represents the 5 mm 1% graphene material (˜20 nanometre particles) in RF PE sample. Curve 3 represents a 5 mm 2% graphene material (˜20 nanometre particles).

From the curves in FIG. 3, the following conclusions can be drawn:
There is a two-stage absorption process, consistent with that reported in the literature.
The gradient of Stage 1 (diffusion control) allows estimation of the diffusion coefficient for the systems. These are shown below.
For Stage 2, the overlap between the base sample curve (curve 1) and the invention embodiment curves (curves 2 and 3) suggest no difference in the rate of osmosis/change to the system.

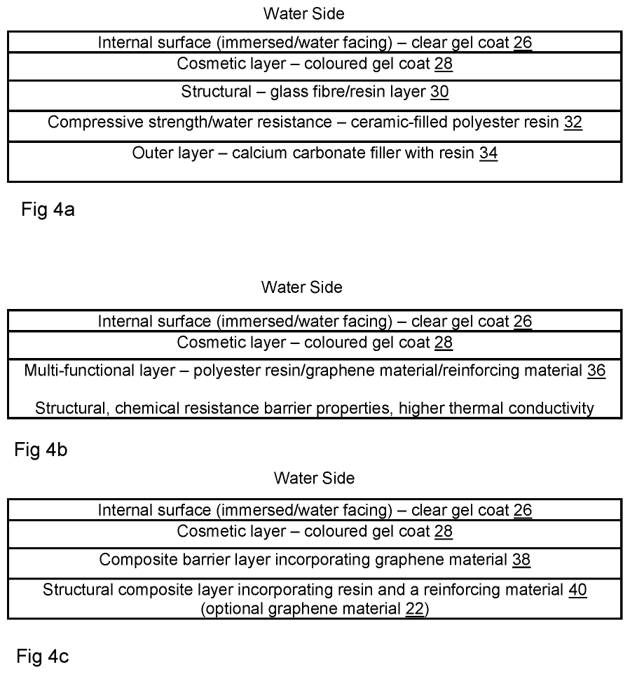

As shown in FIG. 4b, one or more embodiments of the present invention can incorporate graphene material in the structure designed for prolonged immersion in water and therefore otherwise at risk of premature delamination, cracking, bubbling etc., due to osmosis of the water into the structure (e.g. of a boat hull, pool, spa tank or the like).

It will be appreciated that the inventive structure includes use of a composition including a graphene material forming a matrix with a resin and reinforcing fibres.

According to the embodiment represented in FIG. 4b, the composition can include the graphene material, a polyester resin and glass fibre reinforcement.

As shown in FIG. 4c, multiple forms of the composite can be provided in layers, such as a barrier layer containing the graphene material in a resin and a second layer containing reinforcing material.

Other arrangements and configurations falling within the scope of the present invention are possible.

A cosmetic coloured gel coat can be applied to the composition and a clear gel coat applied over the cosmetic coating.

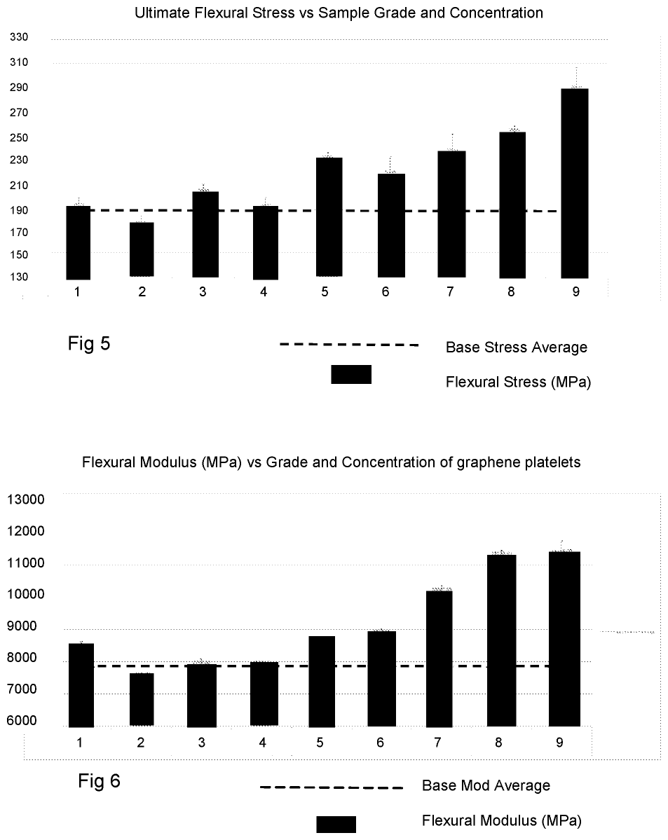

Table 2 shows results for tests as depicted in the chart of Ultimate Flexural Stress vs Sample Grade and Concentration in FIG. 5.

TABLE 2

| | % graphene | Graphene platelets | Ultimate |
|---|---|---|---|
| Sample | platelets | lateral size | Flexural |
| No. | to resin | (microns) | Stress |
| 1 | 0 | N/A | 188 |
| 2 | 0 | N/A | 172 |
| 3 | 0 | N/A | 200 |
| 4 | 0 | N/A | 187 |
| 5 | 0.5 | 20 | 228 |
| 6 | 0.75 | 20 | 215 |
| 7 | 1.0 | 20 | 234 |
| 8 | 0.75 | 10 | 250 |
| 9 | 0.5 | 10 | 286 |

Base samples 1-4 do not contain graphene platelets in the resin of the composite matrix, demonstrating significantly lower ultimate flexural stress compared with samples 5-9 containing graphene platelets according to embodiments of the present invention. The baseline average flexural stress from samples 1-4 is 186.5 MPa. The flexural stress in the samples containing graphene ranges from 215 MPa to 286 MPa.

Table 3 shows results of tests as depicted in the chart of Flexural Modulus (MPa) vs Grade and Concentration of graphene platelets in FIG. 6:

TABLE 3

| | % graphene | Graphene platelets | Flexural |
|---|---|---|---|
| Sample | platelets | lateral size | Modulus |
| No. | to resin | (microns) | (MPa) |
| 1 | 0 | N/A | 8325 |
| 2 | 0 | N/A | 7460 |
| 3 | 0 | N/A | 7797 |
| 4 | 0 | N/A | 7803 |
| 5 | 0.5 | 20 | 8564 |
| 6 | 0.75 | 20 | 8750 |
| 8 | 1.0 | 20 | 10046 |
| 9 | 0.75 | 10 | 11174 |
| 10 | 0.5 | 10 | 11245 |

Base samples 1-4 do not contain graphene platelets in the resin of the composite matrix, demonstrating significantly lower flexural modulus (MPa) compared with samples 5-9 containing graphene platelets according to embodiments of the present invention.

Baseline average flexural modulus is 7846 MPa from samples 1-4 and the flexural modulus ranges from 8564 MPa to 11245 MPa for samples 5-9 loaded with graphene according to embodiments of the present invention.

Structures incorporating one or more embodiments of the present invention can include Interface/Internal surface (immersed/water facing) such as having a clear gel coat 26, a cosmetic layer—coloured gel coat 28, structural—glass fibre/resin layer 30, compressive strength/water resistance—ceramic-filled polyester resin 32, outer layer—calcium carbonate filler with resin 34.

An alternative structure incorporating one or more embodiments of the present invention can include an Interface/Internal surface (immersed/water facing)—clear gel coat 26, a cosmetic layer—coloured gel coat 28, a multi-functional layer—polyester resin/graphene material/reinforcing material 36 having structural, chemical resistance barrier properties, higher thermal conductivity.

An alternative structure incorporating one or more embodiments of the present invention can include an Interface/Internal surface (immersed/water facing)—clear gel coat 26, a cosmetic layer—coloured gel coat 28, a composite barrier layer incorporating graphene material 38, a structural composite layer incorporating resin and a reinforcing material 40, (optional graphene material 22).

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A material composition comprising at least a combination of a resin and a graphene material.

2. The composition of claim 1, further comprising a reinforcing material.

3. The composition of claim 2, wherein the reinforcing material comprises one or more of:
a glass fibre material;
a carbon fibre material;
a poly-paraphenylene terephthalamide and/or other synthetic material;
fibers;
matting; and
mesh.

4. The composition of claim 1, wherein the resin is or includes at least one of a polyester resin (PE), vinyl ester resin, an epoxy resin and any other resin base.

5. The composition of claim 1, wherein the graphene material comprises one or more of:
an osmotic barrier material;
graphene;
functionalised graphene;
graphene oxide;
graphene nano particles;
oxygen; and
at least one oxygen-containing group.

6. The composition of claim 5, wherein the graphene material has a volumetric lateral size in the range 100 nanometres to 100 microns.

7. The composition of claim 5, wherein the oxygen or the at least one oxygen-containing group:
is bonded to or intercalated at the edges of graphene platelets; or
includes at least one of:
a carboxylate;
an ester;
an epoxy; and
a carbonyl group.

8. The composition of claim 5, wherein the at least one oxygen containing group is present in the graphene material in quantities of 0.5% to 10% wt.

9. The composition of claim 1, wherein the graphene material provides:
up to 5% by weight (% wt) of the composition;
up to 2% wt of the composition;
between 1% wt and 2.5% wt of the composition; or
2% wt of the composition.

10. A product comprising a composition according to claim 1.

11. The product of claim 10, comprising a boat hull, a pipe, a swimming pool, a spa or a tank.

12. The product according to claim 11, wherein the product is a pipe, the pipe comprising:
a lining of the composition; and
a cementitious or concrete material;
wherein the composition is in multiple layers.

13. A method of producing a product for prolonged immersion or submersion in water, the method comprising:
providing a composition according to claim 1;
coating the composition with a coloured gel coat; and
subsequently coating the coloured gel coat with a protective top coat.

14. The method of claim 13, wherein:
the composition is provided as at least a first layer and a second layer;
at least one of the first layer and the second layer is provided as a barrier layer; and
the composition is applied by at least one of spraying, painting, rollering and pouring.

15. The method of claim 13, wherein the composition is created by applying the resin with the graphene material dispersed therein to a reinforcing material.

16. A water-resistant composite including a matrix of a graphene material and a resin.

17. The water-resistant composite of claim 16, wherein:
the water-resistant composite further includes a reinforcing material; and
the graphene material comprises one or more of the list consisting of:
functionalised graphene;
oxygen;
an oxygen-containing group; and
graphene platelets that are dispersed within the resin.

18. The water-resistant composite of claim 17, wherein the graphene platelets are between 100 nanometres to 100 microns in a lateral dimension of the platelets.

19. The water-resistant composite of claim 16, wherein the graphene material provides up to 5% by weight (% wt) of the composite.

20. The water-resistant composite of claim 16, wherein:
the composite is part of a swimming pool, a spa, a boat hull, a tank, a water tank or waste water tank, piping, a storage vessel, cladding or roofing material; and
the composite is provided in at least one layer having an additional reinforcing material and at least one other layer not having the reinforcing material.
